(19) United States
(12) Patent Application Publication
(10) Pub. No.: US 2024/0088408 A1
(43) Pub. Date: Mar. 14, 2024

(54) CORRALLED AIR INFLOW MANIFOLD

(71) Applicant: AFC ENERGY PLC, Cranleigh, Surrey (GB)

(72) Inventors: Richard CARTWRIGHT, Cranleigh, Surrey (GB); Christopher Thomas REYNOLDS, Cranleigh, Surrey (GB); Neill Devereux MAYNARD, Cranleigh, Surrey (GB); Roland BLANCH-OJEA, Cranleigh, Surrey (GB)

(21) Appl. No.: 18/261,640

(22) PCT Filed: Jan. 14, 2022
(86) PCT No.: PCT/GB2022/050080

§ 371 Date: Jul. 14, 2023

(30) Foreign Application Priority Data
Jan. 15, 2021 (GB) 2100554.1

(51) Int. Cl. H01M 8/0265; B60L 53/54; H01M 8/0606; H01M 8/083; H01M 8/2484

(52) U.S. Cl. CPC H01M 8/0265; B60L 53/54; H01M 8/0606; H01M 8/083; H01M 8/2484; B60L 53/57; H01M 2250/20

(57) ABSTRACT

An air supply arrangement for air flow plates (5) of electrochemical cells (3) within a fuel cell stack (1). Each air flow plate (5) has a gas exchange volume (19). A common air supply pipe (11) supplies air to the air flow plates (5). There is an air supply region (35) and a separate air distribution conduit (15) for each air flow plate (5). Each air distribution conduit (15) provides an air header volume (43) and has an inlet and an outlet. The common air supply pipe (11) is connected to each air supply region (35) and each air supply region (35) is connected to the inlet of each air distribution conduit (15). The outlet of each air distribution conduit (15) is connected to a gas exchange volume (19) and each gas exchange volume (19) extends across the width of the associated air flow plate (5).

The present invention relates to a method for providing gas to gas exchange zones in an electrochemical cell of a fuel cell stack. In particular, the present invention relates to the supply of air, or oxygen, to the electrochemical cells of an alkaline fuel cell stack, as well as to a power supply system comprising the alkaline fuel cell stack, such as for charging electric vehicles or powering an electrical device.

In order to achieve optimum performance from a fuel cell stack it is important to supply air to each of the electrochemical cells in the most uniform manner possible. The gas exchange zone of each individual fuel cell of the fuel cell stack must receive a sufficient amount of air. That air must be evenly distributed across the surface of the air exchange zone in each individual electrochemical cell.

According to a first aspect of the present invention there is provided an air supply arrangement for supplying air to a plurality of air flow plates within a fuel cell stack, wherein each of the air flow plates has an associated gas exchange volume, and wherein the air supply arrangement comprises a common air supply pipe for supplying air to the air flow plates, an air supply region for each air flow plate that forms part of the common air supply pipe, a separate air distribution conduit for each air flow plate, wherein each air distribution conduit extends across at least part of the width of the air flow plate, provides an air header volume and has at least one inlet and at least one outlet, the common air supply pipe is fluidly connected to each air supply region and each air supply region is fluidly connected to the at least one inlet of each air distribution conduit, the outlet of each air distribution conduit is fluidly connected to the associated one of the plurality of gas exchange volumes and each gas exchange volume extends across at least part of the width of the associated air flow plate, and wherein the air distribution conduit is elongate and extends across substantially all of the width of the gas exchange volume.

Preferably, each air distribution conduit further comprises a flow restriction between its air supply region and its at least one inlet. Preferably, at least one edge of the flow restriction (33) is tapered or stepped.

Preferably, each air distribution conduit tapers outwardly from a point furthest from its air supply region such that the cross-sectional area of each air distribution conduit increases to a maximum area at, or near to, its air supply region. This arrangement is advantageous because it assists with an even distribution of air across the air exchange volume.

Preferably, the outlet from each air distribution conduit comprises an array of air inlet channels which are fluidly connected to the associated gas exchange volume.

Preferably, the common air supply pipe is provided nearer to one side of the fuel cell stack and for each of the air flow plates the air supply region is provided nearer to one side of the air distribution conduit and the air distribution conduit is provided with a longer tapered region on one side of the air supply region and a shorter tapered region on the other side of the air supply region.

Preferably, the air header volume of the air distribution conduit is defined, in part at least, by the air flow plate. In a further embodiment the air distribution conduit is an aperture in the air flow plate.

Preferably, the fuel cell stack further comprises an electrolyte flow plate located on one side of the air flow plate and a fuel flow plate located on the other side of the air flow plate, wherein the air header volume of the air distribution conduit is defined by the air flow plate, the electrolyte flow plate and the fuel flow plate. In an alternative embodiment, the air distribution conduit could be defined solely by the air flow plate.

Preferably, the air header volume is defined by the side wall of an aperture that passes through the entire depth of the air flow plate, in a direction perpendicular to the surface of the air flow plate, by a solid wall of the electrolyte flow plate and by a solid wall of the fuel flow plate, wherein the air supply region is provided as part of the air header volume and the common air supply pipe is fluidly connected to the air distribution conduit via the air supply region. This arrangement is advantageous because it enables the air distribution conduit to have a large volume whilst maintaining a minimum thickness for the air flow plate.

Preferably, the air flow plate, the electrolyte flow plate and the fuel flow plate are each provided with an air supply region, wherein each of those three air supply regions overlap and a section of the common air supply pipe is formed by them.

Preferably, the air inlet channels are defined by recesses cut into the face of the air flow plate and by a surface on an electrolyte plate.

Preferably, the air supply region is a circular hole that passes through the entire depth of the air flow plate, in a direction perpendicular to the surface of the air flow plate, and is located nearer to one side of the air flow plate than to the other side, the air distribution conduit is formed by an aperture that extends through the entire depth of the air flow plate, in a direction perpendicular to the surface of the air flow plate, it extends across the top portion of the air flow plate and includes the air supply region, a long tapered region, which extends away from one side of the air supply region, a short tapered region, which extends away from the opposite side of the air supply region, and the flow restriction which is in the form of a necked region and which is located between the long tapered region and the air supply region, and wherein the air distribution conduit has a bottom surface that is provided with an array of air inlet channels that that are fluidly connected between the air distribution conduit and the gas exchange volume and thus form the outlet from the air distribution conduit.

Preferably, the gas exchange volume is formed by an aperture that extends through the entire depth of the air flow plate, in a direction perpendicular to the surface of the air flow plate, and further comprising an outlet from the gas exchange volume in the form of an array of air outlet channels which are fluidly connected to an air collector channel, which is fluidly connected to an air outlet region.

According to a second aspect of the present invention there is provided a fuel cell stack comprising a plurality of electrochemical cells, each electrochemical cell having an air supply arrangement according to the first aspect of the present invention.

According to a third aspect of the present invention there is provided a power supply system for charging or powering an electrical device, comprising a fuel cell stack according to the second aspect of the present invention and a power supply control system electrically connected to the fuel cell stack, and having a connector mechanism, operable to electrically connect the power supply control system to an electrical device.

In some example arrangements, the power supply system of the third aspect of the present invention may comprise an ammonia cracker system, for processing ammonia to produce hydrogen gas, and a fuel conveyor channel connecting the ammonia cracker system to the fuel cell stack, operable to convey the hydrogen gas from the ammonia cracker system to the fuel cell stack. The fuel gas may consist predominantly of hydrogen, where 99.999% is hydrogen. Alternatively, the percentage of hydrogen might be 99.95%, or 99%. It is also envisaged that the fuel could be ˜75% hydrogen, ˜25% nitrogen with up to 1,000 parts per million of ammonia. The hydrogen may be supplied by an ammonia cracker system, as mentioned above, or it may be supplied by a steam methane reformer, which can utilise methane or biomethane. The hydrogen may also be supplied by an electrolyser. Hydrogen produced using an ammonia cracker system might have a composition of ˜75% hydrogen, ˜25% nitrogen and 0 to ˜1,000 parts per million of residual ammonia.

According to a fourth aspect of the present invention there is provided an electric vehicle charging station comprising a power supply system according to the third aspect of the present invention. In use, an electric vehicle can draw up next to the electric vehicle charging station and an electrical connection can be made between the electric vehicle and the electric vehicle charging station in order to transfer electrical energy to the electric vehicle, for example to charge the batteries on the electric vehicle.

The present invention will be described here with reference to the following figures.

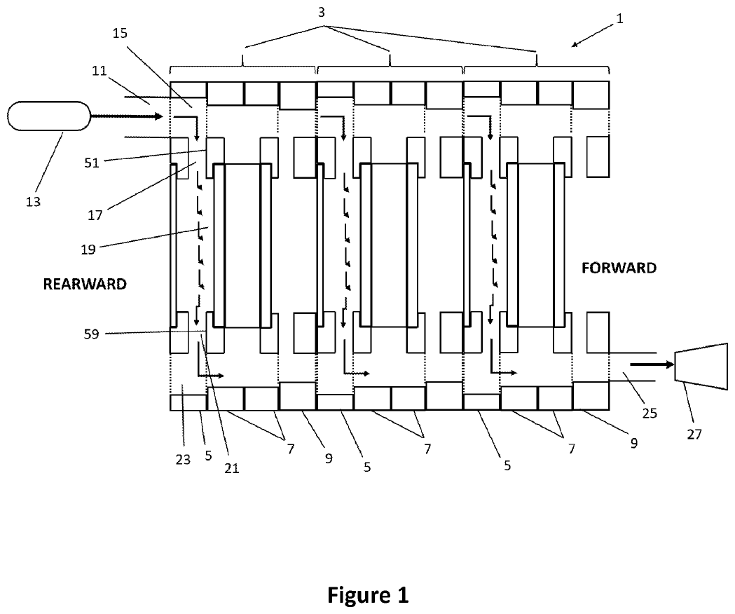

FIG. 1 is a schematic illustration of a cross-section of three cells of a fuel cell stack showing the air flow through the cells when viewed from the side;

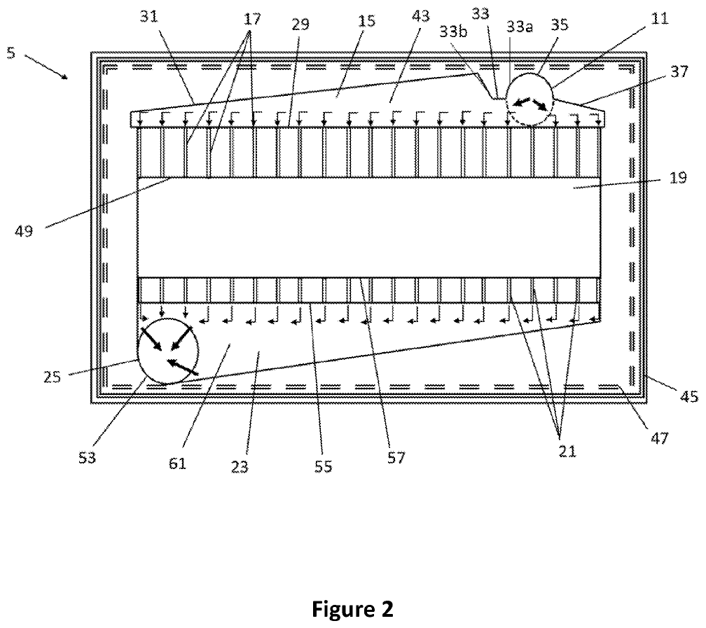

FIG. 2 is a schematic illustration of an air flow plate from one of the cells of the fuel cell stack of FIG. 1 showing the air flow through the plate when viewed from a forward side;

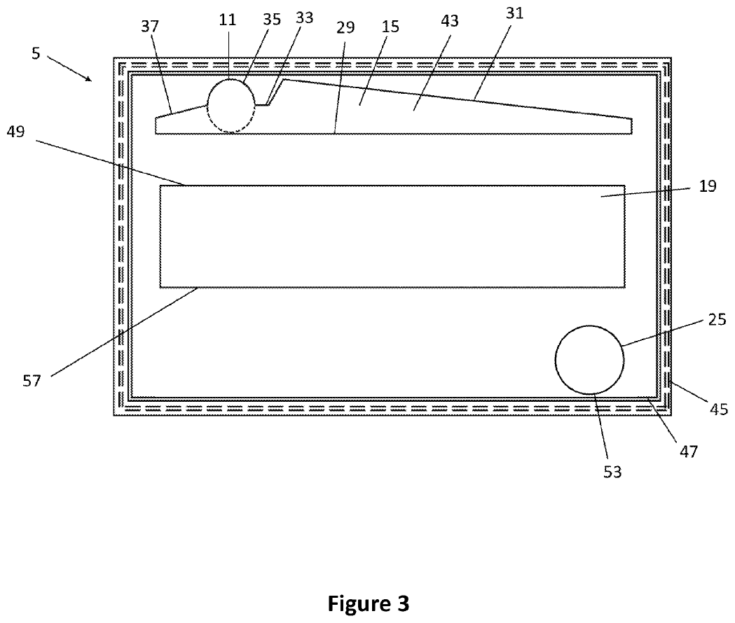

FIG. 3 is a schematic illustration of an air flow plate from one of the cells of the fuel cell stack of FIG. 1 showing the air flow through the plate when viewed from a rearward side;

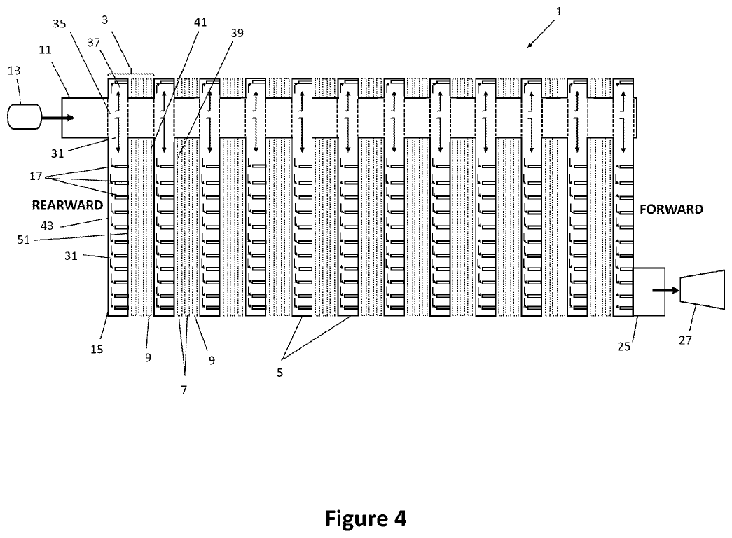

FIG. 4 is a schematic illustration of a cross-section of a fuel cell stack showing the air flow path into the air flow plates of a multi-plate fuel cell stack when viewed from above;

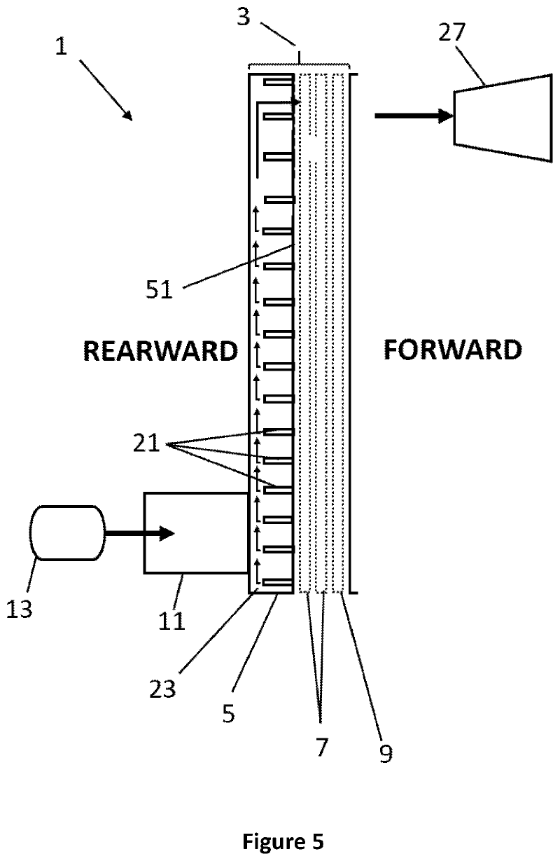

FIG. 5 is a schematic illustration of a cross-section of a fuel cell stack showing the air exit path from the end plate of a multi-plate fuel cell stack when viewed from below;

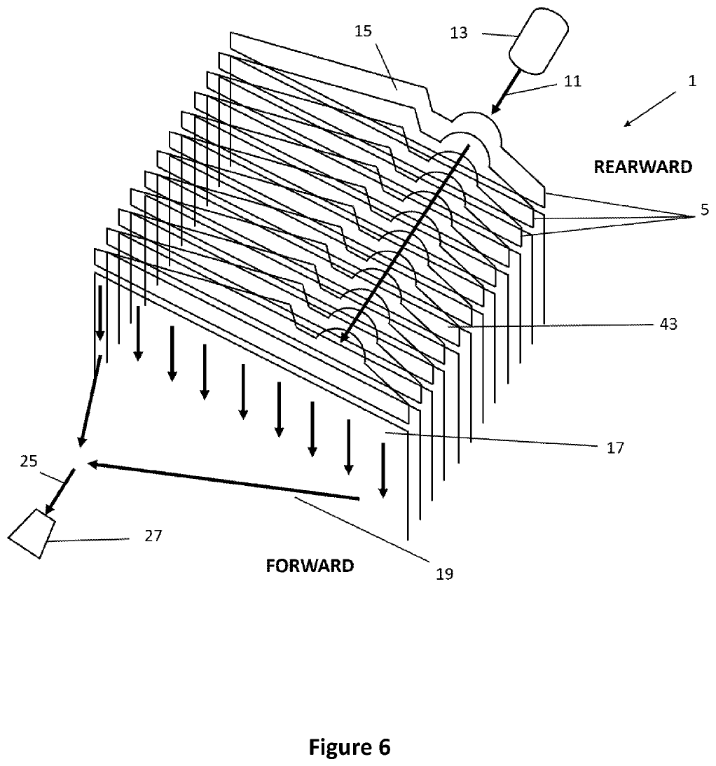

FIG. 6 is a schematic perspective view illustrating the air fuel flow path through the fuel cell stack of FIG. 3; and

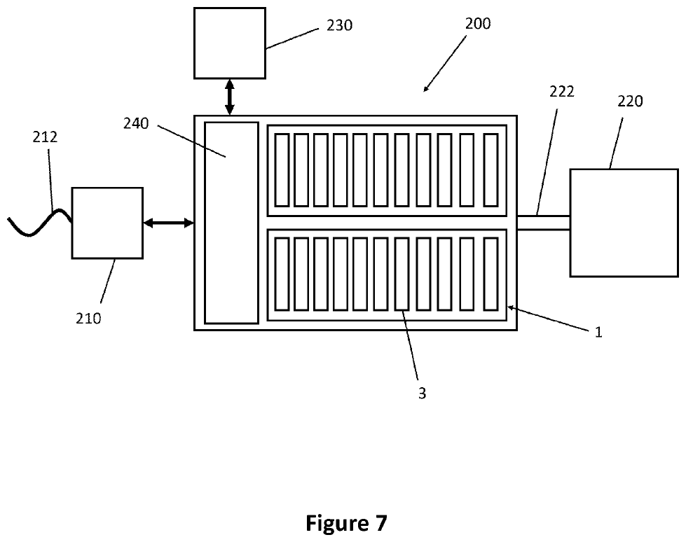

FIG. 7 is a block diagram of an example power supply system for charging an electric vehicle.

An embodiment of electrochemical cells in a fuel cell stack is shown in FIG. 1. The fuel cell stack 1 comprises three electrochemical cells 3. The electrochemical cells 3 are shown in cross-section and the inflows to and outflows from the electrochemical cells 3 are shown. The figure is schematic and the arrangement of those inflows and outflows has been chosen for the ease of showing all of those inflows and outflows in a single cross-section. The illustrated arrangement is not necessarily representative of the relative positioning of the inflows and outflows that would occur in a real fuel cell stack 1. The electrochemical cells 3 each comprise an air flow plate 5, two electrolyte flow plates 7 and a fuel flow plate 9. A common air supply pipe 11 is connected to a source of air 13 and to an air distribution conduit 15 of each air flow plate 5. Air inlet channels 17 run between the distribution conduit 15 and a gas exchange volume 19. Air outlet channels 21 run between the gas exchange volume 19 and an air collector channel 23. A common air outlet pipe 25 is connected to the air collector channel 23 and to an air vent 27.

FIG. 2 illustrates the air flow plate 5, which is made from a thin rectangular sheet of a polymer material. The width of the air flow plate 5 is greater than its height and the depth of the air flow plate 5 is small compared to its width and height. The air flow plate 5 has three regions where the material of the sheet is removed entirely, so that there are three openings through the depth of the air flow plate 5. The first opening is for the air distribution conduit 15, the second is for the gas exchange volume 19 and the third is for the common air outlet pipe 25.

The air distribution conduit 15 is elongate, located in an upper portion of the air flow plate 5 and extends across the majority of the width of the air flow plate 5. A flat air inlet entry surface 29 is provided at the bottom of the distribution conduit 15 and that air inlet entry surface 29 is parallel to the long edges of the air flow plate 5. An elongate long tapered region 31 extends upwardly from the flat inlet entry surface 29 and tapers outwardly in the plane of the air flow plate 5 at a shallow angle from its left hand end towards its right hand end and then tapers inwardly at an acute angle, from its point of maximum height, to a necked region 33 (when the air flow plate 5 is viewed from its forward side, as shown in FIG. 2). The necked region 33 extends upwardly from the flat inlet entry surface 29 and at its left hand end it is joined to the long tapered region 31 by a left edge 33b and at its right hand end it is joined to a circular air supply region 35 by a right edge 33a. The skilled reader will understand that ‘left’ and ‘right’ are only representative of a particular embodiment, as shown in the figures. In other embodiments, the edge (33b) of the necked region distal to the common air supply pipe 11 is joined to the long tapered edge 31, and the edge proximal (33a) to the common air supply pipe 11 is adjacent to the common air supply pipe 11, and the associated air supply region 35.

In some embodiments, the necked region 33 may have a length which is 50% of the length of the air supply region 35, or more. It will be appreciated that where the air supply region 35 is circular, then this length will equal the radius or greater of said air supply region. In some embodiments, the necked region 33 has at least one edge which is substantially parallel to any of the four edges of the plate 5. In some embodiments, the left edge 33b of necked region 33 is tapered (i.e. is a tapered edge). In some embodiments, the tapered edge of the necked region 33 is such that the width of the necked region 33 increases towards the nearest perimeter edge of the plate 5 to the necked region 33. In some embodiments, the left edge 33b is tapered, meaning that it may be a straight or curved tapered edge, or stepped. In some embodiments ‘stepped’ means alternating between tapered edges and edges parallel to an edge of the perimeter of the plate 5. It can be understood by the skilled person that any tapered feature may have an edge which is stepped in this way. For example, the upper edge of the long and short tapered regions (31, 37). Another possibility is that ‘stepped’ means that such edges are undulating but tapered across the whole length of the long and short tapered regions (31, 37), and/or the left-hand edge 33b of the necked region 33.

The height of the necked region 33 is less than the maximum height of the long tapered region 31 and the air supply region 35. A short tapered region 37 extends upwardly from the flat inlet entry surface 29 and tapers inwardly in the plane of the air flow plate 5 at a shallow angle from its left hand end, where its height is the same as the height of the necked region 33, to its right hand end. The air supply region 35 is located towards the right hand end of the air flow plate and thus the long tapered region 31 has a length that is considerably greater than the length of the short tapered region 37.

In a fuel cell stack 1 the air flow plate 5 is clamped between an electrolyte flow plate 7 and a fuel flow plate 9, as shown in FIG. 1 and in FIG. 4. The rearward side of the electrolyte flow plate 7 and the forward side of the fuel flow plate 9 are each provided with a flat surface 39, 41 respectively. Those flat surfaces 39,41 completely overlap the air distribution conduit and each serve as an end face for the air distribution conduit 15. In other words, the air distribution conduit 15 may be an aperture, meaning that the entire depth of the air flow plate is a void in the region defined by the air distribution conduit. Having the air distribution conduit be an aperture in this way allows for a maximal volume, which is advantageous for the operation of the fuel cell. Therefore, the electrolyte flow plate 7, the air flow plate 5 and the fuel flow plate 9 together form a defined air header volume 43 within the air distribution conduit 15. A forward seal 45 is provided on the forward surface of the air flow plate 5 to seal with the electrolyte flow plate 7. A rearward seal 47 is provided on the rearward surface of the air flow plate 5 to seal with the fuel flow plate 9. Those seals 45, 47 provide an airtight seal around the edges of the air distribution conduit 15. The electrolyte flow plate 7 and the fuel flow plate 9 are also each provided with a circular air supply region 35. The circular air supply regions 35 of the air flow plate 5, the electrolyte flow plate 7 and the fuel flow plate 9 are co-axially aligned and form a section of the common air supply pipe 11. Therefore, there is a fluid path into and out from the air distribution conduit 15 via the electrolyte flow plate 7 and the fuel flow plate 9.

Each of the air inlet channels 17 runs downwardly from the flat air inlet entry surface 29 to a flat air inlet exit surface 49. The air inlet entry surface 29 and the air inlet exit surface 49 are parallel to each other. The air inlet channels 17 are uniformly spaced between the left hand end and the right hand end of the gas exchange volume 19. The air inlet channels 17 are elongate and their length is much greater than their width. The width of the air inlet channels 17 is consistent along their length. The depth of the air inlet channels 17 is less than the depth of the air flow plate 5. Thus, three sides of the air inlet channel 17 are formed by the air flow plate 5 and a fourth side of the air inlet channel 17 is formed by a flat surface 51 of the electrolyte flow plate 7 which abuts the air flow plate 5 when the electrochemical cell 3 is assembled.

The gas exchange volume 19 is rectangular in cross-section, in the plane of the air flow plate 5, and its long sides are parallel to the long sides of the air flow plate 5 and its short sides are parallel to the short sides of the air flow plate 5. The air inlet exit surface 49 forms the upper boundary of the gas exchange volume 19 and the air inlet channels 17 are in fluid communication with the gas exchange volume 19.

The air collector channel 23 tapers in the plane of the air flow plate 5 outwardly, at a shallow angle, from its right hand end to its left hand end, to its maximum width at its left hand end. A circular air outlet region 53 is located at the bottom left hand corner of the air collector channel 23. The electrolyte flow plate 7 and the fuel flow plate 9 also have an air outlet region 49 and the three air outlet regions 49 form a section of the common air outlet pipe 25. The air collector channel is formed by a recess within the air flow plate 5. The air collection volume 61 is formed by the walls of the recess and a flat surface 59 of the electrolyte flow plate 7 which abuts the air flow plate 5 when the electrochemical cell 3 is assembled.

A flat air outlet exit surface 55 is provided at the top of the air conduit 23. The air outlet exit surface 55 is parallel to the long edges of the air flow plate 5. A flat air outlet entry surface 57 is located above the air outlet exit surface 55 and parallel to it. The air outlet entry surface forms the lower boundary of the gas exchange volume 19. Each of the air outlet channels 21 runs downwardly from the air outlet entry surface 57 to the air outlet exit surface 55. The air outlet channels 21 are spaced between the left hand end and the right hand end of the gas exchange volume 19. The air outlet channels 21 are elongate and their length is much greater than their width. The depth of the air outlet channels 21 is less than the depth of the air flow plate 5. Thus, three sides of the air outlet channel 21 are formed by the air flow plate 5 and a fourth side of the air inlet channel 17 is formed by the flat surface 59.

FIG. 3 shows the rearward side of the air flow plate 5. The three cut-outs from the air flow plate 5 can be seen, i.e. the air distribution conduit 15, the gas exchange volume 19 and the common air outlet pipe 25. The air inlet channels 17 and the air outlet channels 21 are not visible because these channels are not cut through the entire depth of the air flow plate 5, as explained above.

FIG. 4 is a cross-sectional view of a stack 1 of twelve electrochemical cells 3, viewed from above. The means for supplying air from the air source 13 to the gas exchange volumes 19 is made up of the common air supply pipe 11, the air supply regions 35, the air distribution channels 15 and the air inlet channels 17.

FIG. 5 is a cross-sectional view of the end fuel cell of a multi-cell fuel cell stack, viewed from below. The means for removing air from the gas exchange volumes 19 is made up of the air outlet channels 21, the air collector channels 23, the air outlet regions 53 and the common air outlet pipe 25.

In use, air is supplied to the fuel cell stack 1 from the air source 13. The air flows along the common air supply pipe 11 until it reaches the air supply region 35 of a first electrochemical cell 3. Some of the air flows from the air supply pipe 11 through the air supply region 35 and into the short tapered region 37 and into the long tapered region 31 through the necked region 33. The restriction to flow presented by the necked region 33 means that only a proportion of the air flows through the necked region 33 of the first electrochemical cell 33. The rest of the air passes on to the other electrochemical cells 3 within the fuel cell stack 1. In some embodiments, the common air supply pipe 11 includes the short-tapered region 37, such that rather than the short tapered region 37 being an aperture in the air flow plate 7 only, it is an aperture through the whole stack 1 and is contiguous with said common air supply pipe 11.

The air has now entered the air distribution conduit 15 which is made up of the supply region 35, the short tapered region 37 and the long tapered region 31 and which forms the air header volume 43. The tapering surfaces of the short tapered region 37 and the long tapered region 31 direct the air flows into all regions of the distribution conduit 15. The air then passes across the air inlet entry surface 29, into the air inlet channels 17, flows along those inlet channels 17 and exits from them, across the air inlet exit surface 49, into the gas exchange volume 19. The air is then available for use by the electrochemical cell 3.

The air passes across the exchange volume 19 in a generally downwards direction until it reaches the air outlet entry surface 57. The air that crosses the air outlet entry surface 57, passes into the air outlet channels 21, flows along those outlet channels 21 and exits from them, across the air outlet exit surface 55, into the air collector channel 23. The air is then channeled by the tapered form of the air collector channel 23 towards the air outlet region 53 and then into the common air outlet pipe 25 along which it passes until it reaches a vent 27.

FIG. 6 illustrates schematically how air flows through the fuel cell stack 1 from a source 13, through the common air supply pipe 11, through the air header volumes 43, across the gas exchange volumes 19 and then out through the common air outlet pipe 25 to be vented.

FIG. 7 illustrates an example electric vehicle (EV) charging system 200 comprising a charging terminal 210, to which an electric vehicle (not shown) can be electrically connected by a cable 212, a fuel cell stack 1 of electrochemical fuel cells 3 is connected to a balance of plant and power electronics 240 as disclosed herein, a battery storage system 230 may or may not be connected, either an ammonia cracking system, a hydrogen gas storage system or a direct hydrogen feed from another source 220 is connected via a tube 222 for conveying a hydrogen gas blend, e.g. a blend of hydrogen and nitrogen from the ammonia cracking or hydrogen system 220 to the fuel cell stack 1. Some example EV charging systems 200 may have the aspect of allowing EVs to be charged in remote locations, in which there is little or no access to an electricity grid.

GB2589611 relates to reactant gas plates useable in a fuel cell, though no air distribution conduit is shown in detail therein. WO2004045003 relates to a polymer membrane fuel cell, particularly a proton exchange membrane (PEM) fuel cell. JP H06267559 relates to a fuel cell producing electricity using undefined fuel and oxidizing agents. JP 2009004230 relates to a compact and lightweight configuration for a fuel cell involving an inlet buffer for gas flow. US 2013196249 relates to solid polymer electrolyte fuel cells, in particular involving an inlet buffer for gas flow. EP 2348567 relates to a solid polymer electrolyte membrane-based fuel cell, in particular involving a gas distribution section for equalizing the distribution of gas to each reaction gas channel.

None of the abovementioned publications demonstrate the advantageous features of the present invention.

1. An air supply arrangement for supplying air to a plurality of air flow plates (5) within a fuel cell stack (1), wherein each of the air flow plates (5) has an associated gas exchange volume (19), and wherein the air supply arrangement comprises a common air supply pipe (11) for supplying air to the air flow plates (5), an air supply region (35) for each air flow plate (5) that forms part of the common air supply pipe (11), a separate air distribution conduit (15) for each air flow plate (5), wherein each air distribution conduit (15) extends across at least part of the width of the air flow plate (5), provides an air header volume (43) and has at least one inlet and at least one outlet, the common air supply pipe (11) is fluidly connected to each air supply region (35) and each air supply region (35) is fluidly connected to the at least one inlet of each air distribution conduit (15), the outlet of each air distribution conduit (15) is fluidly connected to the associated one of the plurality of gas exchange volumes (19) and each gas exchange volume (19) extends across at least part of the width of the associated air flow plate (5), and wherein the air distribution conduit (15) is elongate and extends across substantially all of the width of the gas exchange volume (19).

2. An air supply arrangement as claimed in claim 1, wherein each air distribution conduit (15) further comprises a flow restriction (33) between its air supply region (35) and its at least one inlet.

3. An air supply arrangement as claimed in claim 2, wherein at least one edge of the flow restriction (33) is tapered.

4. An air supply arrangement as claimed in any one of claims 1 to 3, wherein each air distribution conduit (15) tapers outwardly from a point furthest from its air supply region (35) such that the cross-sectional area of each air distribution conduit (15) increases to a maximum area at, or near to, its air supply region (35).

5. An air supply arrangement as claimed in any preceding claim, wherein the outlet from each air distribution conduit (15) comprises an array of air inlet channels (17) which are fluidly connected to the associated gas exchange volume (19).

6. An air supply arrangement as claimed in any preceding claim, wherein the common air supply pipe (11) is provided nearer to one side of the fuel cell stack (1) and for each of the air flow plates (5) the air supply region (35) is provided nearer to one side of the air distribution conduit (15) and the air distribution conduit (15) is provided with a longer tapered region (31) on one side of the air supply region (35) and a shorter tapered region (37) on the other side of the air supply region (35).

7. An air supply arrangement as claimed in any preceding claim wherein the air header volume (43) of the air distribution conduit (15) is defined, in part at least, by the air flow plate (5).

8. An air supply arrangement as claimed in claim 7, wherein the air distribution conduit (15) is an aperture in the air flow plate (5).

9. An air supply arrangement as claimed in any preceding claim wherein the fuel cell stack (1) further comprises an electrolyte flow plate (7) located on one side of the air flow plate (5) and a fuel flow plate (9) located on the other side of the air flow plate (5), wherein the air header volume (43) of the air distribution conduit (15) is defined by the air flow plate (5), the electrolyte flow plate (7) and the fuel flow plate (9).

10. An air supply arrangement as claimed in claim 9, wherein the air header volume (43) is defined by the side wall of an aperture that passes through the entire depth of the air flow plate (5), in a direction perpendicular to the surface of the air flow plate (15), by a solid wall of the electrolyte flow plate (7) and by a solid wall of the fuel flow plate (9), wherein the air supply region (35) is provided as part of the air header volume (43) and the common air supply pipe (11) is fluidly connected to the air distribution conduit (15) via the air supply region (35).

11. An air supply arrangement as claimed in claim 10, wherein the air flow plate (5), the electrolyte flow plate (7) and the fuel flow plate (9) are each provided with an air supply region (35), wherein each of those three air supply regions (35) overlap and a section of the common air supply pipe (11) is formed by them.

12. An air supply arrangement as claimed in any one of claim 9, claim 10 or claim 11, wherein the air inlet channels (17) are defined by recesses cut into the face of the air flow plate (5) and by a surface on an electrolyte flow plate (7).

13. An air supply arrangement as claimed in claim 1, wherein the air supply region (35) is a circular hole that passes through the entire depth of the air flow plate (5), in a direction perpendicular to the surface of the air flow plate (15), and is located nearer to one side of the air flow plate (5) than to the other side, the air distribution conduit (15) is formed by an aperture that extends through the entire depth of the air flow plate (5), in a direction perpendicular to the surface of the air flow plate (15), it extends across the top portion of the air flow plate (5) and includes the air supply region (35), a long tapered region (31), which extends away from one side of the air supply region (35), a short tapered region (37), which extends away from the opposite side of the air supply region (35), and the flow restriction (33) which is in the form of a necked region and which is located between the long tapered region (31) and the air supply region (35), and wherein the air distribution conduit (15) has a bottom surface that is provided with an array of air inlet channels (17) that that are fluidly connected between the air distribution conduit (15) and the gas exchange volume (19) and thus form the outlet from the air distribution conduit (15).

14. An air supply arrangement as claimed in claim 13, wherein the gas exchange volume (19) is formed by an aperture that extends through the entire depth of the air flow plate (5), in a direction perpendicular to the surface of the air flow plate (15), and further comprising an outlet from the gas exchange volume (19) in the form of an array of air outlet channels (21) which are fluidly connected to an air collector channel (23), which is fluidly connected to an air outlet region (53).

15. A fuel cell stack (1) comprising a plurality of electrochemical cells (3), each electrochemical cell having an air supply arrangement (10) according to any one of claims 1 to 14.

16. The fuel cell stack (1) of claim 15, further wherein the common air supply pipe 11 includes the short-tapered region (37), said short tapered-region (37) being an aperture extending through each of the plurality of electrochemical cells (3).

17. A power supply system (200) for charging or powering an electrical device, comprising a fuel cell stack (1) as claimed in claim 15 or claim 16, and a power supply control system (210) electrically connected to the fuel cell stack (1), and having a connector mechanism (212), operable to electrically connect the power supply control system (210) to an electrical device.

18. A power supply system (200) as claimed in claim 17, comprising an ammonia cracker system (220), for processing ammonia to produce hydrogen gas, and a fuel conveyor channel (222) connecting the ammonia cracker system (220) to the fuel cell stack (1), operable to convey the hydrogen gas from the ammonia cracker system (220) to the fuel cell stack (1).

19. An electric vehicle charging station comprising a power supply system (200) according to claim 17 or claim 18.
